(19) United States
(12) Patent Application Publication
(10) Pub. No.: US 2010/0153597 A1
(43) Pub. Date: Jun. 17, 2010

(54) Generating Furtive Glance Cohorts from Video Data

(75) Inventors: Robert Lee Angell, Salt Lake City, UT (US); Robert R. Friedlander, Southbury, CT (US); James R. Kraemer, Santa Fe, NM (US)

Correspondence Address: Stewart & Liu PLLC, PO Box 797277, Dallas, TX, 75379, US

(73) Assignee: INTERNATIONAL BUSINESS MACHINES CORPORATION, Armonk, NY (US)

(21) Appl. No.: 12/335,521

(22) Filed: Dec. 15, 2008

(51) Int. Cl. G06F 13/12

(52) U.S. Cl. 710/69

(57) ABSTRACT

The illustrative embodiments described herein provide a computer implemented method, apparatus, and computer program product for generating furtive glance cohorts. In an illustrative embodiment, video data of a monitored population is received and processed to form digital video data. The digital video data includes metadata describing glancing patterns associated with one or more subjects from the monitored population. The digital video is analyzed to identify a set of furtive glance patterns from the glancing patterns. One or more furtive glance attributes for the set of furtive glance cohorts are selected from the set of furtive glance patterns. Thereafter, the set of furtive glance cohorts is generated. The set of furtive glance cohorts have members selected from the monitored population and have at least one furtive glance attribute in common.

### BACKGROUND OF THE INVENTION

1. Field of the Invention

The present invention relates generally to an improved data processing system and in particular to a method and apparatus for generating cohorts from video data. Still more particularly, the present invention relates to a computer implemented method, apparatus, and computer program product for generating a set of furtive glance cohorts having members selected from a population of subjects monitored by video capture devices.

2. Description of the Related Art

A cohort is a group of members selected based upon a commonality of one or more attributes. For example, one attribute may be a level of education attained by employees. Thus, a cohort of employees in an office building may include members who have graduated from an institution of higher education. In addition, the cohort of employees may include one or more sub-cohorts that may be identified based upon additional attributes such as, for example, a type of degree attained, a number of years the employee took to graduate, or any other conceivable attribute. In this example, such a cohort may then be used by an employer to correlate an employee's level of education with job performance, intelligence, or any number of variables.

Cohorts are typically used to facilitate the study or analysis of its members over time. The effectiveness of cohort studies depends upon a number of different factors, such as the length of time that the members are observed, and the ability to identify and capture relevant data for collection. For example, the information that may be necessary to identify attributes of potential members of a cohort may be voluminous, dynamically changing, unavailable, difficult to collect, and/or unknown to the members of the cohort and/or the user selecting members of the cohort. Moreover, it may be difficult, time consuming, or impractical for an individual to access all the information necessary to accurately generate cohorts. Thus, currently developed cohorts may be sub-optimal because individuals lack the skills, time, knowledge, and/or expertise needed to gather cohort attribute information from available sources.

Furtive glances are patterns of observation of people or things in an environment that may indicate the observer's intent to act or cause mischief. For example, a shoplifter present in a retail facility may locate an item of interest then exhibit furtive glance behavior before taking the item and leaving the store. Currently, retail facilities may implement video cameras to monitor customers to identify potential shoplifters by employing a security team to observe customer behavior. However, furtive glances may not be detectable by simple observation because of the number of customers that may have to be monitored. In addition, security personnel may be unable to identify furtive glance behavior due to the lack of training or because furtive glance behavior may be undetectable by human observation.

### SUMMARY OF THE INVENTION

The illustrative embodiments described herein provide a computer implemented method, apparatus, and computer program product for generating a set of furtive glance cohorts. In an illustrative embodiment, video data of a monitored population is received and processed to form digital video data. The digital video data includes metadata describing glancing patterns associated with one or more subjects from the monitored population. The digital video is analyzed to identify a set of furtive glance patterns from the glancing patterns. One or more furtive glance attributes for the set of furtive glance cohorts are selected from the set of furtive glance patterns. Thereafter, the set of furtive glance cohorts is generated. The set of furtive glance cohorts have members selected from the monitored population and have at least one furtive glance attribute in common.

### BRIEF DESCRIPTION OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a data processing system for generating furtive glance cohorts in accordance with an illustrative embodiment;

FIG. 4 is a block diagram depicting glancing patterns that may be detected in video data in accordance with an illustrative embodiment;

FIG. 5 is a flowchart of a process for generating furtive glance cohorts in accordance with an illustrative embodiment;

FIG. 6 is a flowchart depicting steps for processing video data in accordance with an illustrative embodiment; and

FIG. 7 is a flowchart of a process for generating a set of furtive glance cohorts in accordance with an illustrative embodiment.

### DETAILED DESCRIPTION OF THE PREFERRED EMBODIMENT

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

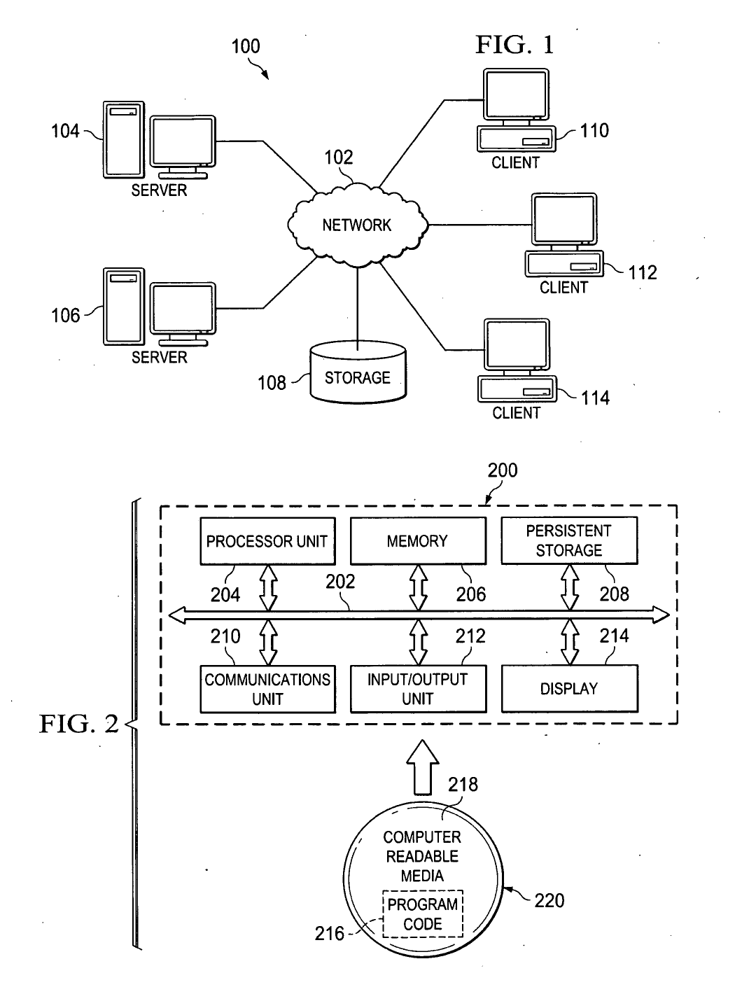

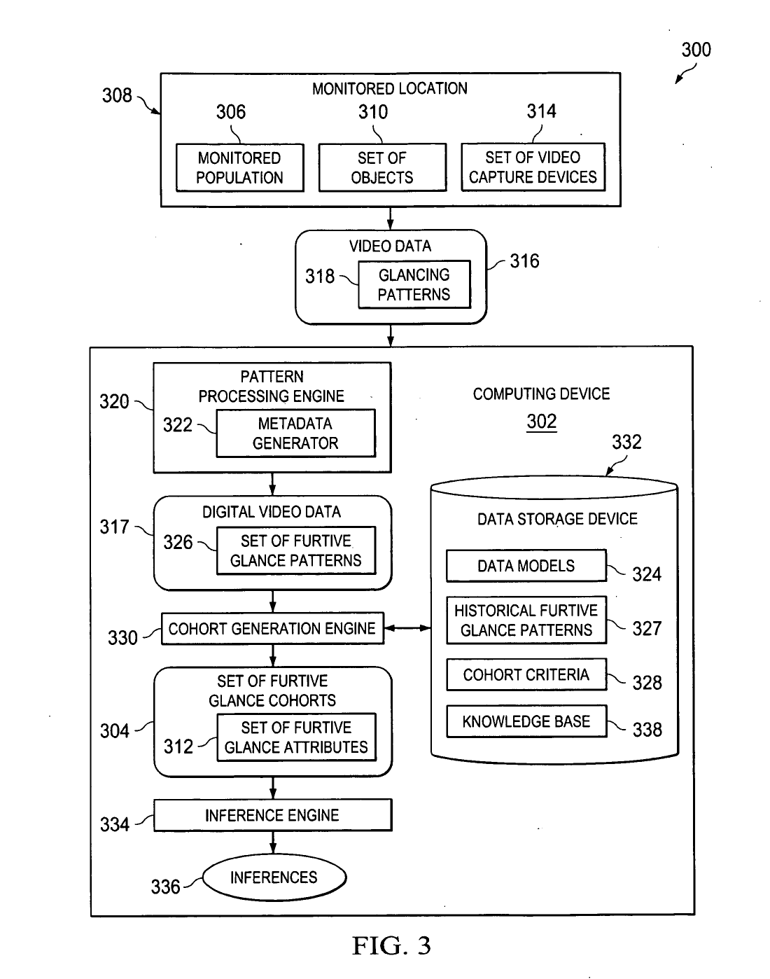

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In an illustrative example, a client computer, such as client 110, may host a glancing pattern processing engine and a cohort generation engine for generating a set of furtive glance cohorts. The set of furtive glance cohorts may be generated from video data captured by a set of video capture devices distributed throughout a monitored location. The monitored location may be, for example, a retail facility, a sports arena, a public transportation facility, or any other location in which a set of monitored subjects may be found. The set of monitored subjects are people present in a monitored location. For example, if the monitored location is a train station, then the set of monitored subjects include the passengers and employees located at the train station.

Once generated, the set of furtive glance cohorts may be used by an inference engine to generate inferences related to the set of furtive glance cohorts. For example, the inferences may identify persons from the set of monitored subjects who may be collaborating on a plan to cause mischief. In addition, the inferences may identify a target of such a plan. For example, a cohort of card players at a casino may be identified based upon common furtive glance attributes selected from a set of furtive glance patterns. In addition, based upon the furtive glancing patterns, the inference engine may determine, for example, that the cohort of card players intend to take a bag of money destined for the casino vault.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 216 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 216 may be a server computer, a client computer, or some other device capable of storing and transmitting program code 216.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Video data collected from a monitored location may include data describing glancing patterns exhibited by persons present in a monitored location. Glancing patterns, which are identified by a glancing pattern processing engine, are patterns of data describing a manner of observation by a set of monitored subjects. The glancing patterns may include innocent forms of observation and furtive glance patterns.

The video data may be processed for transformation into digital video data. In addition, the processing of video data enables the identification of a set of furtive glance patterns from the glancing patterns. Thereafter, a cohort generation engine may select furtive glance patterns from the set of furtive glance patterns as a set of furtive glance attributes for generating a set of furtive glance cohorts. A furtive glance cohort is a group of members who share one or more common furtive glance attributes. Furtive glance attributes are common characteristics exhibited by people in a monitored location.

Video data may be collected by a set of sensors deployed throughout a monitored location. As used herein, the term “set” may refer to one or more. Thus, a set of sensors may be a set formed from a single sensor, or two or more sensors. The set of sensors and the software applications for processing the video data to generate the set of furtive glance cohorts may be implemented in a system-wide monitoring process to quickly and efficiently pass vital information to a real-time computational process. Thus, the embodiments disclosed herein permit a user to create furtive glance cohorts based on video data captured during the monitoring of a monitored population.

Thus, the illustrative embodiments described herein provide a computer implemented method, apparatus, and computer program product for generating furtive glance cohorts. In an illustrative embodiment, video data of a monitored population is received and processed to form digital video data. The digital video data includes metadata describing glancing patterns associated with one or more subjects from the monitored population. The digital video is analyzed to identify a set of furtive glance patterns from the glancing patterns. One or more furtive glance attributes for the set of furtive glance cohorts are selected from the set of furtive glance patterns. Thereafter, the set of furtive glance cohorts is generated. The set of furtive glance cohorts have members selected from the monitored population and have at least one furtive glance attribute in common.

FIG. 3 is a block diagram of a data processing system for generating furtive glance cohorts according to an illustrative embodiment. Data processing system 300 is a data processing system, such as networked data processing system 100 in FIG. 1. In addition, computing device 302 of data processing system 300 may be implemented using any type of computing device, including but not limited to, a main frame, a server, a personal computer, a laptop, a personal digital assistant (PDA), or any other computing device depicted in FIGS. 1 and 2.

Data processing system 300 is configured for generating set of furtive glance cohorts 304. Set of furtive glance cohorts 304 is one or more cohorts having members selected from monitored population 306. Monitored population 306 is a group of people present at monitored location 308. Monitored location 308 is a location capable of being monitored such as, for example, a retail facility, a hospital, a sports arena, a train, a bus, an airplane, a transportation facility, or any other location monitored by set of video capture devices 310. Set of video capture devices 310 may be any sensing device, such as, for example, a video camera. Thus, monitored population 306 may be a single convenience store clerk, or the entire audience at a movie theater.

People from monitored population 306 who have been assigned to a cohort in set of furtive glance cohorts 304 are also referred to as cohort members. Members are selected for inclusion in one or more cohorts in set of furtive glance cohorts 304 based upon set of furtive glance attributes 312. Set of furtive glance attributes 312 is one or more characteristics exhibited and shared by members of a cohort. In particular, set of furtive glance attributes 312 is observational characteristics exhibited by individuals in monitored population 306. Examples of observational characteristics include, without limitation, a threshold rate of eye movement, a threshold rate of head movement, a number of times an object from set of objects 314 is viewed, a number of times an object from set of objects 314 is viewed in a predefined time period, or any other similar type of characteristic.

Set of objects 314 is the collection of objects located in monitored location 308 that is viewed by monitored population. For example, set of objects 314 may include people, places, and things within monitored location 308. Examples of objects that may be included in set of objects 314 include, without limitation, items of clothing, entryways, windows, luggage, plants, equipment, or any other object present at monitored location 308.

Members of one furtive glance cohort in set of furtive glance cohorts 304 may also be members of a second furtive glance cohort if those members possess the requisite attribute or attributes for each cohort. Thus, a passenger on a bus may be included in a first furtive glance cohort having the common attribute of the number of objects that the passenger views in a threshold amount of time. In addition, the same passenger may be a member of a second furtive glance cohort having the common attribute of a threshold speed or acceleration by which the eyes move from one object to another.

Set of video capture devices 310 generates video data 316. Video data 316 is data describing the motions and actions of monitored population 306. For example, video data 316 may include data describing the speed at which a passenger on a train reads a line of text from a newspaper, the number of times that the passenger looks up from the newspaper to observe nearby passengers, how long the passenger looks at each nearby passenger, the speed at which the passenger's eyes move from one passenger to another, the speed at which the passenger's head turns, and any other motions or actions taken by passengers on the train.

Over time, as video data 316 is aggregated, glancing patterns 318 become detectable. Glancing patterns 318 are patterns of data present in video data 316 that describe the manner in which people from monitored population 306 observe set of objects 314. For example, a glancing pattern in glancing patterns 318 may indicate that all passengers in a train either stared out the train windows or directed their gaze to items in their possession, such as newspapers, books, or communications devices. In addition, glancing patterns 318 may indicate that the passengers all directed their attention to the conductor when the conductor passed through the train car to collect tickets. Glancing patterns 318 may also indicate that the passengers seated in the train would observe the passengers exiting the train and all new passengers getting on the train at each stop and in a particular manner.

Glancing patterns 318 are detected in video data 316 by pattern processing engine 320. Pattern processing engine 320 is a software component for processing video data 316 to form digital video data 317. Digital video data 317 is video data 316 that has been processed and converted; if necessary, into digital format usable for generating set of furtive glance cohorts 304. For example, video data 316 may be captured by set of video capture devices 310 in analog format. Thus, video data 316 may require conversion into digital format to be compatible with other software components for generating set of furtive glance cohorts 304.

Pattern processing engine 320 includes metadata generator 322. Metadata generator 322 is a software component for generating metadata tags usable for identifying glancing patterns 318. In one embodiment, metadata generator 322 generates metadata tags describing the data in video data 316. Thereafter, pattern processing engine 320 references the metadata tags for identifying glancing patterns 318. In particular, pattern processing engine 320 may identify glancing patterns 318 from video data 316 by processing video data 316 and/or any associated metadata tags using data models 324.

Data models 324 are a set of one or more data models for processing video data 316, for identifying glancing patterns 318, that may then be used to form furtive glance attributes for cohort generation. A data model is a model for structuring, defining, organizing, imposing limitations or constraints, and/or otherwise manipulating data or metadata to produce a result. A data model may be generated using any type of modeling method or simulation including, but not limited to, a statistical method, a data mining method, a causal model, a mathematical model, a behavioral model, a psychological model, a sociological model, or a simulation model.

In addition to identifying glancing patterns 318, the processing of digital video data 317 also identifies set of furtive glance patterns 326 from glancing patterns 318. Set of furtive glance patterns 326 is one or more glancing patterns from glancing patterns 318 which correspond to furtive glance behavior. In one embodiment, cohort generation engine 330 identifies set of furtive glance patterns 326 from digital video data 317 by comparing glancing patterns 318 with historical furtive glance patterns 327. Historical furtive glance patterns 327 is a set of one or more glancing patterns encountered over time, at monitored location 308, that have been identified as furtive glancing patterns. Thus, pattern processing engine 320 may process video data 316 to identify set of furtive glance patterns 326 by comparing metadata tags associated with glancing patterns 318 with metadata tags associated with historical furtive glance patterns 327.

Set of furtive glance patterns 326 may also be identified according to cohort criteria 328. Cohort criteria 328 is a set of criteria and/or guidelines for identifying furtive glance behavior and for generating set of furtive glance cohorts 304. For example, cohort criteria 328 may specify threshold glancing metrics associated with furtive glance behavior. In one non-limiting example, cohort criteria 328 may specify a threshold number of objects viewed by an observer from monitored population 306 in a predefined period of time. If a glancing pattern from glancing patterns 318 indicates that an observer from monitored population 306 has exceeded that threshold, the glancing pattern is identified as a furtive glance pattern. In another example, cohort criteria 328 may specify a threshold rate of eye movement between objects in set of objects 314. One or more glancing patterns from glancing patterns 318 may be identified as one or more furtive glance patterns because metadata for those glancing patterns meets or exceeds the threshold rate of eye movement described in cohort criteria 328. Cohort criteria 328 may include other criteria or thresholds that may be referenced to identifying furtive glance patterns from glancing patterns 318.

In another embodiment, the analysis of glancing patterns 318 using data models 324 may enable identification of set of furtive glance patterns 326. The analysis of glancing patterns 318 in data models 324 may identify unexpected or unusual glancing patterns. For example, glancing patterns exhibited in a nightclub may be different than glancing patterns exhibited in a library, due to the larger number of stimuli presented to patrons of a nightclub. In other words, a normal glancing pattern exhibited in a nightclub may have otherwise been identified as a furtive glance pattern if captured in a library. However, furtive glancing patterns may be identified by identifying glancing patterns that fail to conform to other glancing patterns identified in a monitored location. Processing glancing patterns 318 in data models 324 may enable another method of identifying furtive glance patterns.

Pattern processing engine 320 sends digital video data 317 to cohort generation engine 330 for generating set of furtive glance cohorts 304. Cohort generation engine 330 is a software program that generates set of furtive glance cohorts 304 from information contained in digital video data 317. In an alternate embodiment, cohort generation engine 330 may request digital video data 317 from a data storage device where digital video data 317 is stored. The data storage device may be a data storage device, such as data storage 332. Data storage 332 is a device for storing data. Data storage 332 may be, for example, a portable computer diskette; a hard disk; a random access memory (RAM); a read-only memory (ROM); an erasable programmable read-only memory (EPROM or Flash memory); an optical fiber; a portable compact disc read-only memory (CDROM); an optical storage device; a transmission media, such as those supporting the Internet or an intranet; or a magnetic storage device. In an alternate embodiment, data storage 332 may be located in a remote location accessible to computing device 302 via a network, such as network 102 in FIG. 1.

In other embodiments, pattern processing engine 320 automatically sends digital video data 317 to cohort generation engine 330 in real time as digital video data 317 is generated. In addition, another embodiment may have pattern processing engine 320 send digital video data 317 to cohort generation engine 330 upon the occurrence of a predetermined event. The predetermined event may be the expiration time; the completion of task, such as processing video data 316; the occurrence of a timeout event; a user request; or any other predetermined event. Thus, the illustrative embodiments may utilize digital video data 317 in real time as digital video data 317 is generated. The illustrative embodiments also may utilize digital video data 317 that is pre-generated and/or stored in a data storage device until the digital video data is retrieved at some later time.

Cohort generation engine 330 generates set of furtive glance cohorts 304 from digital video data 317 with reference to cohort criteria 328. Cohort criteria 328 may specify guidelines for grouping members into cohorts based upon furtive glance attributes derived from set of furtive glance patterns 326 present in digital video data 317. For example, cohort criteria 328 may specify that set of furtive glance cohorts 304 should include cohorts based on a threshold number of objects an observer from monitored population 306 views in a predefined amount of time, a threshold rate of eye movement, a threshold rate of head movement, or any other glancing metric. Consequently, cohort generation engine 330 may select only those members from monitored population 306 who share the common furtive glance patterns for inclusion in a furtive glance cohort. The common furtive glance patterns may form the furtive glance attributes for the furtive glance cohort.

In one embodiment, cohort generation engine 330 provides set of furtive glance cohorts 304 to inference engine 334. Inference engine 334 is a software component, such as a computer program, which derives Inferences 336 based upon input, such set of furtive glance cohorts 304. Inferences 336 are conclusions regarding possible future events or future changes in the attributes of cohorts that are drawn or inferred. Inferences 336 are derived in accordance with knowledge base 338. Knowledge base 338 is a collection of facts, criteria, factors, and other information that may be used for, among other things, generating Inferences 336. For example, set of furtive glance cohorts 304 may include three members of monitored population 306 exhibiting furtive glance behavior. The furtive glance behavior is identified by set of furtive glance attributes 312. Further, monitored location 308 may be a bank. In addition, knowledge base 338 may include department of corrections records for one or more members of set of furtive glance cohorts 304 indicating that the one or more members have previously robbed banks. Thus, inference engine 334 may generate Inferences 336 indicating that members of set of furtive glance cohorts 304 may intend to rob the bank.

In another example, set of furtive glance cohorts 304 may be analyzed by inference engine 334 to identify cohorts of people from monitored population 306 who may be collaborating on a scheme to steal a wallet from an unsuspecting person in monitored location 308. Inference engine 334 may identify the cohort by the manner in which they look at one another, the unsuspecting victim, and the exhibition of set of furtive glance patterns 326.

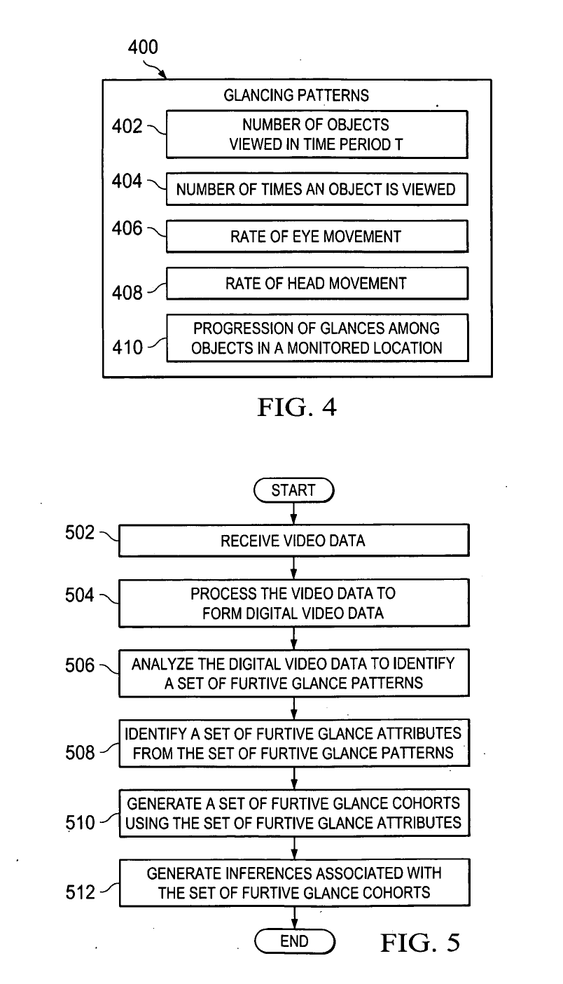

FIG. 4 is a block diagram depicting glancing patterns that may be detected in video data in accordance with an illustrative embodiment. Glancing patterns 400 are glancing patterns, such as glancing patterns 318 in FIG. 3.

Examples of glancing patterns in glancing patterns 400 include, without limitation, glancing pattern 402, 404, 406, 408, and 410. Glancing pattern 402 is a pattern based on the number of different objects viewed in a predefined time period. Glancing pattern 404 is a pattern based upon the number of times an object is viewed. Glancing pattern 406 is a pattern based on a rate of eye movement. Glancing pattern 408 is a pattern based on a rate of head movement. Glancing pattern 408 is a pattern based on a progression of glances among objects in a monitored location.

Glancing patterns 400 may be aggregated for a monitored population, such as monitored population 306 in FIG. 3. In addition, glancing patterns 400 may be collected and maintained for each observer in the monitored population.

FIG. 5 is a flowchart of a process for generating furtive glance cohorts in accordance with an illustrative embodiment. The process depicted in FIG. 5 may be implemented by software components of a computing device. For example, steps 502-506 may be implemented in a pattern processing engine, such as pattern processing engine 320 in FIG. 3. Steps 508-510 may be implemented in a cohort generation engine, such as cohort generation engine 330 in FIG. 3, and step 512 may be implemented in an inference engine, such as inference engine 334 in FIG. 3.

The process begins by receiving video data (step 502). The video data is video data, such as video data 316 in FIG. 3. The video data is processed to form digital video data (step 504). Thereafter, the digital video data is analyzed to identify a set of furtive glance patterns (step 506). A set of furtive glance attributes are identified from the set of furtive glance patterns with reference to cohort criteria (step 508).

The process generates a set of furtive glance cohorts using cohort criteria and the set of furtive glance attributes (step 510). Thereafter, inferences associated with the set of furtive glance cohorts may be generated (step 512), and the process terminates.

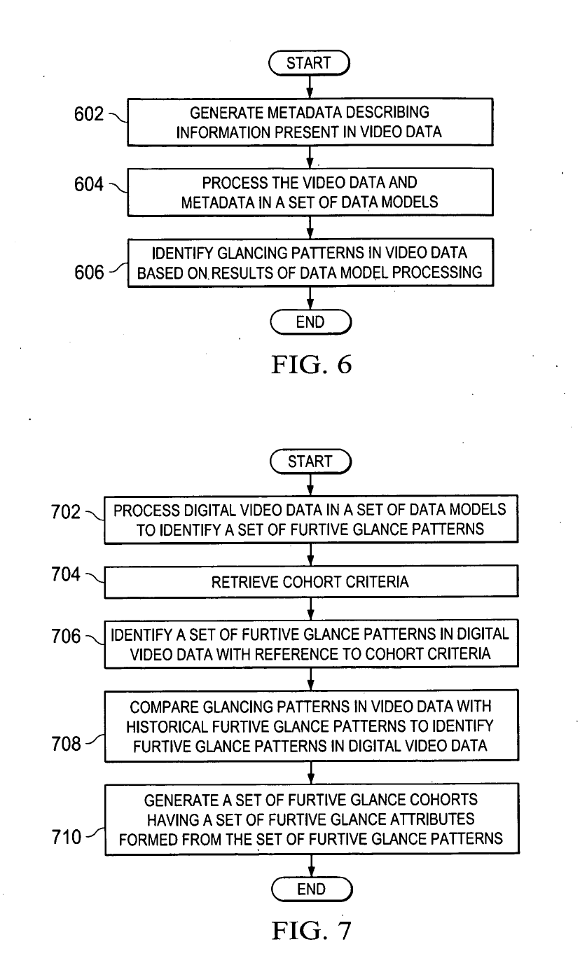

FIG. 6 is a flowchart depicting steps for processing video data in accordance with an illustrative embodiment. The process depicted in FIG. 6 may be implemented in a software component, such as pattern processing engine 320 in FIG. 3.

The process begins by generating metadata describing information present in video data (step 602). The video data and associated metadata are processed in data models (step 604). The process then identifies glancing patterns present in video data based on the results of the data model processing (step 606), and the process terminates thereafter.

FIG. 7 is a flowchart of a process for generating a set of furtive glance cohorts in accordance with an illustrative embodiment. The process depicted in FIG. 7 may be implemented in a software component, such as cohort generation engine 330 in FIG. 3.

Digital video data is processed in a set of data models to identify a set of furtive glance patterns (step 702). The process then retrieves cohort criteria (step 704) and identifies a set of furtive glance patterns in digital video data with reference to cohort criteria (step 706). The process also compares glancing patterns in video data with historical furtive glance patterns to identify furtive glance patterns in digital video data (step 708). Thereafter, once the furtive glance patterns have been identified, the process generates a set of furtive glance cohorts having a set of furtive glance attributes formed from the set of furtive glance patterns (step 710), and the process terminates. Specific furtive glance patterns may be selected for generating the set of furtive glance attributes according to guidelines, such as those specified in cohort criteria.

Thus, the illustrative embodiments described herein provide a computer implemented method, apparatus, and computer program product for generating furtive glance cohorts. In one embodiment, video data of a monitored population is received and processed to form digital video data. The digital video data includes metadata describing glancing patterns associated with one or more subjects from the monitored population. The digital video is analyzed to identify a set of furtive glance patterns from the glancing patterns. One or more furtive glance attributes for the set of the set of furtive glance cohorts are selected from the set of furtive glance patterns. Thereafter, the set of furtive glance cohorts is generated. The set of furtive glance cohorts have members selected from the monitored population and have at least one furtive glance attribute in common.

The furtive glance cohorts generated by the method and apparatus disclosed above enable the grouping of members into cohorts having similar furtive glance attributes. Once formed, the furtive glance cohorts may then be included in a system-wide monitoring process to quickly and efficiently pass vital information to a real-time computational process. The generation of furtive glance cohorts in the manner described above obviates the need for manual selection of cohort attributes, thereby allowing the generation of more robust furtive glance cohorts. Once formed, the furtive glance cohorts may be used in, for example and without limitation, demographic research and safety and/or security applications.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating a set of furtive glance cohorts, the computer implemented method comprising:
responsive to receiving video data of a monitored population, processing the video data to form digital video data, wherein the digital video data comprises metadata describing glancing patterns associated with one or more subjects from the monitored population;
analyzing the digital video data to identify a set of furtive glance patterns from the glancing patterns, wherein one or more furtive glance attributes for the set of furtive glance cohorts are selected from the set of furtive dance patterns; and
generating the set of furtive glance cohorts comprising members selected from the monitored population, wherein each member of a cohort in the set of furtive glance cohorts has at least one furtive glance attribute in common.

2. The computer implemented method of claim 1, wherein processing the digital video data further comprises:
processing the video data in a set of data models for identifying glancing patterns in the video data.

3. The computer implemented method of claim 1, wherein analyzing the digital video data further comprises:
comparing the glancing patterns to a set of historic glancing patterns to identify the set of furtive glance patterns.

4. The computer implemented method of claim 1, wherein generating the set of furtive glance cohorts further comprises:
identifying a set of furtive glance attributes from the set of furtive glance patterns, wherein the set of furtive glance attributes is identified from one or more set of furtive glance patterns using cohort criteria.

5. The computer implemented method of claim 1, wherein the set of furtive glance patterns comprises at least one of a threshold rate of eye movement, a threshold rate of head movement, a number of objects viewed in a predefined period of time, and a number of times an object is viewed.

6. The computer implemented method of claim 1 further comprising:
generating inferences using the set of furtive glance cohorts, wherein the inferences indicate a possible future action taken by the members of the set of furtive glance cohorts.

7. The computer implemented method of claim 1 further comprising:
updating historical furtive glance patterns with patterns in the set of furtive glance patterns present in the digital video data.

8. A computer program product for generating furtive glance cohorts, the computer program product comprising:
a computer recordable-type medium;
first program instructions for processing the video data to form digital video data in response to receiving video data of a monitored population, wherein the digital video data comprises metadata describing glancing patterns associated with one or more subjects from the monitored population;
second program instructions for analyzing the digital video data to identify a set of furtive glance patterns from the glancing patterns, wherein one or more furtive glance attributes for the set of furtive glance cohorts are selected from the set of furtive glance patterns;
third program instructions for generating the set of furtive glance cohorts comprising members selected from the monitored population, wherein each member of a cohort in the set of furtive glance cohorts has at least one furtive glance attribute in common; and
wherein the first program instructions, the second program instructions, and the third program instructions are stored on the computer recordable-type medium.

9. The computer program product of claim 8, wherein the first program instructions further comprise program instructions for processing the video data in a set of data models for identifying glancing patterns in the video data.

10. The computer program product of claim 8, wherein the second program instructions further comprises instructions for comparing the glancing patterns to a set of historic glancing patterns to identify the set of furtive glance patterns.

11. The computer program product of claim 8, wherein the third program instructions further comprise program instructions for identifying a set of furtive glance attributes from the set of furtive glance patterns, wherein the set of furtive glance attributes is identified from one or more set of furtive glance patterns using cohort criteria.

12. The computer program product of claim 8 wherein the set of furtive glance patterns comprises at least one of a threshold rate of eye movement, a threshold rate of head movement, a number of objects viewed in a predefined period of time, and a number of times an object is viewed.

13. The computer program product of claim 8 further comprising:
fourth program instructions for generating inferences using the set of furtive glance cohorts, wherein the inferences indicate a possible future action taken by the members of the set of furtive glance cohorts, and wherein the fourth program instructions are stored on the computer recordable-type medium.

14. The computer program product of claim 8, further comprising:
fifth program instructions for updating historical furtive glance patterns with patterns in the set of furtive glance patterns present in the digital video data, wherein the fifth program instructions are stored on the computer recordable-type medium.

15. An apparatus for generating furtive glance cohorts, the apparatus comprising:
a bus system;
a memory connected to the bus system, wherein the memory includes computer usable program code; and
a processing unit connected to the bus system, wherein the processing unit executes the computer usable program code to process the video data to form digital video data in response to receiving video data of a monitored population, wherein the digital video data comprises metadata describing glancing patterns associated with one or more subjects from the monitored population; analyze the digital video data to identify a set of furtive glance patterns from the glancing patterns, wherein one or more furtive glance attributes for the set of furtive glance cohorts are selected from the set of furtive glance patterns; and generate the set of furtive glance cohorts comprising members selected from the monitored population, wherein each member of a cohort in the set of furtive glance cohorts has at least one furtive glance attribute in common.

16. The apparatus of claim 15, wherein the processing unit further executes the computer usable program code to process the video data in a set of data models for identifying glancing patterns in the video data.

17. The apparatus of claim 15, wherein the processing unit further executes the computer usable program code to compare the glancing patterns to a set of historic glancing patterns to identify the set of furtive glance patterns.

18. The apparatus of claim 15, wherein the processing unit further executes the computer usable program code to identify a set of furtive glance attributes from the set of furtive glance patterns, wherein the set of furtive glance attributes is identified from one or more set of furtive glance patterns using cohort criteria

19. A system for generating furtive glance cohorts, the system comprising:
a set of sensors, wherein the set of sensors captures video data, wherein the video data comprises glancing patterns;
a pattern processing engine, wherein the pattern processing engine forms digital video data from the patient care data; and
a cohort generation engine, wherein the cohort generation engine generates a set of furtive cohorts from the digital video data, wherein each member in the set of furtive glance cohorts share at least one furtive glance attribute in common.

20. The system of claim 19, further comprising:
an inference engine, wherein the inference engine generates inferences using the set of furtive glance cohorts, wherein the inferences indicate a possible future action taken by the members of the set of furtive glance cohorts.
